(19) United States
(12) Patent Application Publication
(10) Pub. No.: US 2012/0147520 A1
(43) Pub. Date: Jun. 14, 2012

(54) CAPACITOR STRUCTURE AND MANUFACTURING METHOD THEREOF

(75) Inventor: Yuan-Wen Liu, New Taipei City (TW)

(73) Assignee: CAP-TAN TECHNOLOGY CO., LTD., New Taipei City (TW)

(21) Appl. No.: 13/226,483

(22) Filed: Sep. 6, 2011

(30) Foreign Application Priority Data
Dec. 10, 2010 (TW) 099143228

(51) Int. Cl. H01G 4/06; B32B 37/12; B05D 5/12

(52) U.S. Cl. 361/311; 427/79; 156/60; 427/80

(57) ABSTRACT

A capacitor structure and a manufacturing method thereof. The capacitor structure includes a first conductor layer, a dielectric layer and a second conductor layer. The first conductor layer has a first metal material and a second metal material. The first metal material is formed with voids and the second metal material is filled in the voids via hot melt. Accordingly, in the first conductor layer, the second metal material is filled into the voids of the first metal material by means of hot melt to bond with the first metal material. In this case, the thermal treatment temperature can be effectively lowered and the electrical conductivity of the capacitor structure can be increased. Also, the strength of the capacitor structure is increased.

This application claims the priority of benefit of Taiwan patent application number 099143228 filed on Dec. 10, 2010.

### BACKGROUND OF THE INVENTION

1. Field of the Invention

The present invention relates generally to a capacitor structure and a manufacturing method thereof, and more particularly to a capacitor structure, which is made from a complex material to increase the electrical conductivity and lower the thermal treatment temperature.

2. Description of the Related Art

Recently, electronic integrated circuits have been required to work at lower and lower voltage, higher and higher frequency and lower and lower noise. With respect to solid electrolytic capacitor, it has been more and more emphasized to reduce equivalent series resistance (ESR) and equivalent series inductance (ESL). Metal powders such as tantalum, niobium, titanium, tungsten and molybdenum are used as the material of the anode of the solid electrolytic capacitor. Especially, the capacitor adopting tantalum has low ESR and large capacitance. Therefore, such capacitors have been rapidly developed and popularly applied to cell phones and personal computers as parts thereof. Recently, the capacitor has been required to have higher capacitance and lower ESR. In order to more increase the capacitance of the capacitor, fine tantalum powder with larger specific surface area has been developed to serve as the material of the anode of the capacitor.

Please refer to FIG. 1, which is a sectional view of a conventional solid electrolytic capacitor. The solid electrolytic capacitor 10 includes a tantalum sintered body 11 having a Ta₂O₅ layer 12 formed on the surface of the tantalum sintered body 11. A solid electrolyte layer 13, a graphite layer 14 and a silver layer 15 are sequentially coated on the Ta₂O₅ layer 12. The solid electrolytic capacitor 10 is manufactured in a manner as follows:

First, a bonder is added into the tantalum powder to have a total 3˜5 mass %. After fully mixed, a solid rectangular body in particle form with 2.4 mm length, 3.4 mm width and 1.8 mm thickness is molded by means of a press mold. When press molded, the load is preferably 3˜15MN (meganewton)/m². The volume density of the press mold is preferably 3200˜4000 kg/m³. Preferably, the bonder is at least one material selected from a group consisting of camphor, stearic acid, polyvinyl alcohol and naphthalene. The solid rectangular body in particle form is heated at about 2900° C.˜3020° C. and sintered. The sintering temperature can be properly set according to the specific surface area. Accordingly, a porous tantalum sintered body 11 is achieved. The tantalum sintered body 11 goes through a conversion treatment to form the Ta₂O₅ layer 12 formed on the surface of the tantalum sintered body 11 as an anode. The conversion treatment is performed, for example, at 80° C. in a phosphoric acid aqueous solution of a concentration of 0.6 mass % with the voltage boosted to 10˜20V under 140 A/g current density for six hours.

Second, a solid electrolyte layer 13 such as polypyrrole and polythiophen, a graphite layer 14 and a silver layer 15 are sequentially coated on the surface of the tantalum sintered body 11. Then, an external terminal 18 (anode) is connected to the tantalum sintered body 11 and another external terminal 19 (cathode) is connected to the silver layer 15 via a conductive bonder 16. Finally, the entire body is enclosed in a resin layer 17 and aged to obtain the solid electrolytic capacitor 10.

According to the above, the solid rectangular body in particle form is heated at a high temperature of 2900° C.˜3020° C. and sintered to obtain the porous tantalum sintered body 11. Therefore, a high-temperature thermal treatment equipment is needed for the sintering process. Such high-temperature thermal treatment equipment is quite expensive so that the manufacturing cost is relatively high.

According to the aforesaid, the conventional technique has the following shortcomings:
1. A high-temperature thermal treatment equipment is needed for the sintering process, which is quite expensive.
2. The manufacturing cost is relatively high.

### SUMMARY OF THE INVENTION

A primary object of the present invention is to provide a capacitor structure and a manufacturing method thereof. The capacitor structure is made from a complex material to effectively lower the thermal treatment temperature.

A further object of the present invention is to provide the above capacitor structure and the manufacturing method thereof. The capacitor structure is made from a complex material to increase the electrical conductivity.

To achieve the above and other objects, the capacitor structure of the present invention includes a first conductor layer, a dielectric layer and a second conductor layer. The first conductor layer has a first metal material and a second metal material. The first metal material is formed with voids. The second metal material is filled in the voids. The dielectric layer is formed on the first metal material. A solid electrolyte layer and a graphite layer are sequentially disposed on the dielectric layer. The second conductor layer is coated on the graphite layer. The first conductor layer is connected with a first external terminal, while the second conductor layer is connected with a second external terminal. The second conductor layer and one end of the first external terminal and one end of the second external terminal are enclosed in an enclosure layer.

The manufacturing method of the capacitor structure of the present invention includes steps of: forming a first conductor layer having a first metal material and a second metal material; forming a dielectric layer on the first conductor layer; and forming a second conductor layer on one side of the dielectric layer, which side is distal from the first conductor layer. The second metal material is filled into the voids of the first metal material via hot melt to bond with the first metal material. Accordingly, in the first conductor layer, the second metal material is filled into the voids of the first metal material by means of hot melt to bond with the first metal material. In this case, the thermal treatment temperature can be effectively lowered and the electrical conductivity of the capacitor structure can be increased.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a sectional view of a conventional solid electrolytic capacitor;

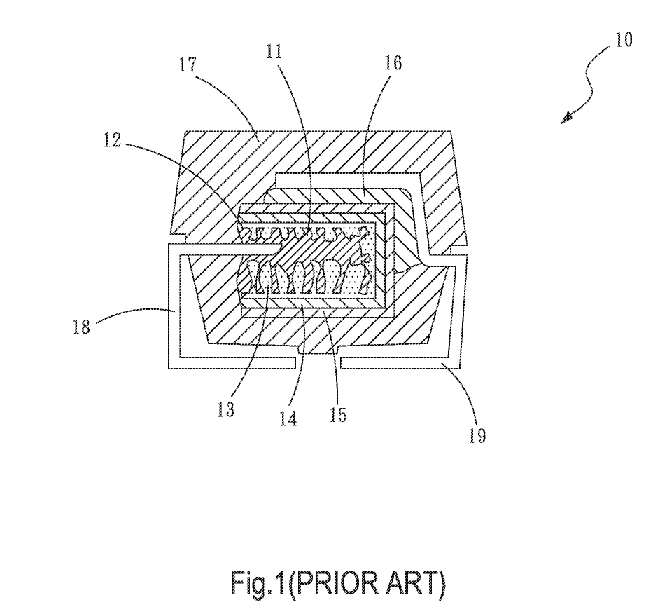

FIG. 2 is a sectional view of the capacitor structure of the present invention;

FIG. 3 is a sectional view of a part of the capacitor structure of the present invention; and

FIG. 4 is a flow chart of the manufacturing method of the capacitor structure of the present invention.

### DETAILED DESCRIPTION OF THE PREFERRED EMBODIMENTS

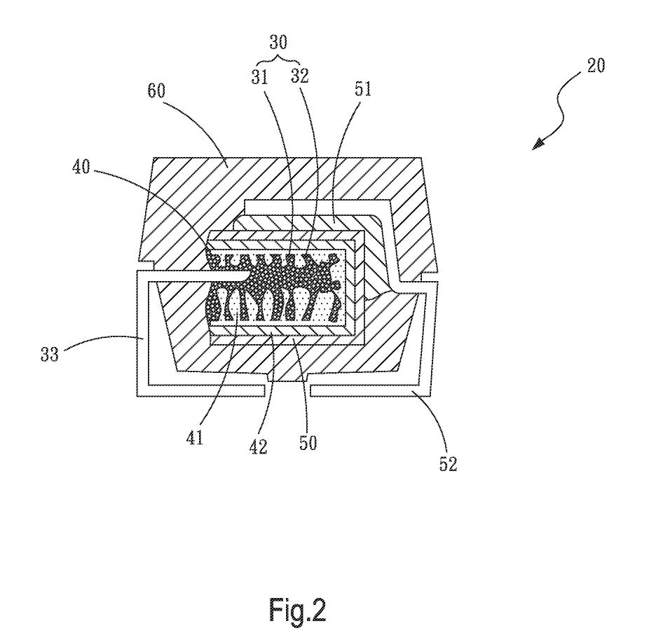

Please refer to FIG. 2, which is a sectional view of the capacitor structure of the present invention. The capacitor structure 20 includes a first conductor layer 30 having a first metal material 31 and a second metal material 32. The first conductor layer 30 is coated on a surface of a first external terminal 33. The first metal material 31 is formed with voids. The second metal material 32 is disposed in the voids. The first and second metal materials 31, 32 are formed on the surface of the first external terminal 33. A dielectric layer 40 is formed on the first metal material 31. In addition, a solid electrolyte layer 41 and a graphite layer 42 are sequentially disposed on the dielectric layer 40. A second conductor layer 50 is further coated on the graphite layer 42. The second conductor layer 50 is electrically connected with a second external terminal 52. The second conductor layer 50 and one end of the second external terminal 52 are enclosed in an enclosure layer 60.

The first metal material 31 is selected from a group consisting of tantalum (Ta) and niobium (Nb). The second metal material 32 is selected from a group consisting of aluminum (Al) and copper (Cu). The first metal material 31 is coated on the surface of the first external terminal 33 and formed with the voids. The second metal material 32 is disposed in the voids. The dielectric layer 40 is formed on both the first and second metal materials 31, 32. The dielectric layer 40 is selected from a group consisting of Ta₂O₅ and Nb₂O₃ or from a group consisting of Al₂O₃ and CuO. The solid electrolyte layer 41 and the graphite layer 42 are sequentially disposed on the dielectric layer 40. The second conductor layer 50 is further coated on the graphite layer 42. The second conductor layer 50 is silver (Ag). The second conductor layer 50 is electrically connected with the second external terminal 52 via a conductive bonder 51. The first and second external terminals 33, 52 are made from a material selected from a grouping consisting of aluminum (Al), silver (Ag), copper (Cu), nickel (Ni), tin (Sn), tantalum (Ta), niobium (Nb), aluminum alloy (Al alloy) and silver alloy (Ag alloy). The enclosure layer 60 is made from a material selected from a group consisting of resin, ethyl rubber, propyl rubber and butyl rubber. The second conductor layer 50 and one end of the second external terminal 52 are enclosed in the enclosure layer 60.

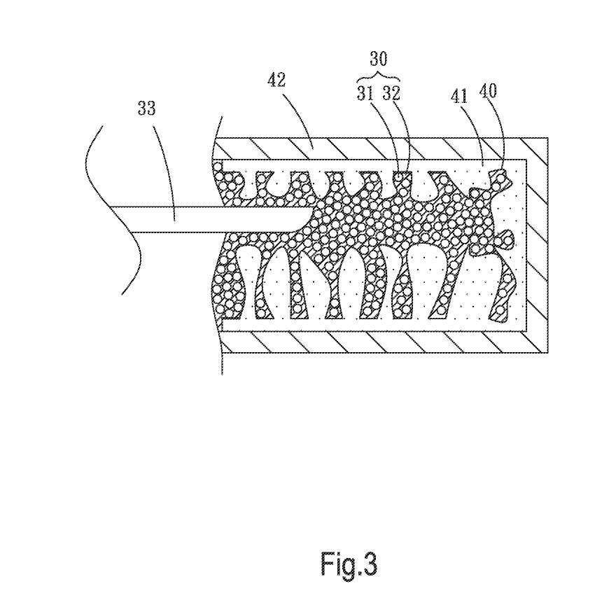

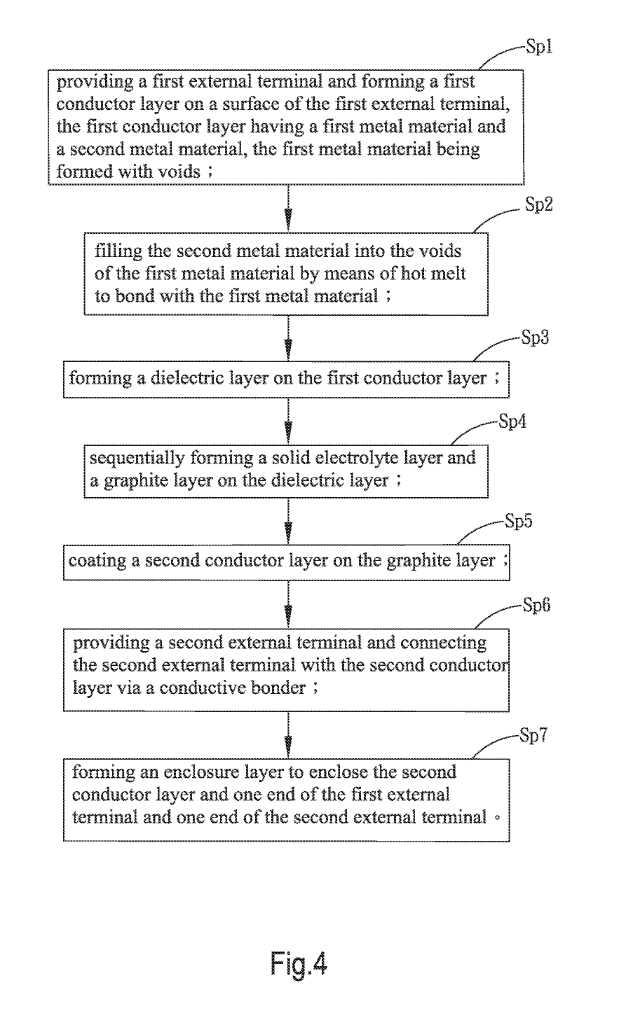

Please now refer to FIGS. 2, 3 and 4. FIG. 3 is a sectional view of a part of the capacitor structure of the present invention. FIG. 4 is a flow chart of the manufacturing method of the capacitor structure of the present invention. The manufacturing method of the capacitor structure of the present invention includes steps of:

Sp1: providing a first external terminal and forming a first conductor layer on a surface of a first external terminal, the first conductor layer having a first metal material and a second metal material, the first metal material being formed with voids;
Sp2: filling the second metal material into the voids of the first metal material by means of hot melt to bond with the first metal material;
Sp3: forming a dielectric layer on the first conductor layer;
Sp4: sequentially forming a solid electrolyte layer and a graphite layer on the dielectric layer;
Sp5: coating a second conductor layer on the graphite layer;
Sp6: providing a second external terminal and connecting the second external terminal with the second conductor layer via a conductive bonder; and
Sp7: forming an enclosure layer to enclose the second conductor layer and one end of the first external terminal and one end of the second external terminal.

The first conductor layer 30 is coated on the surface of the first external terminal 33. The first metal material 31 is selected from a group consisting of tantalum (Ta) and niobium (Nb). The second metal material 32 is selected from a group consisting of aluminum (Al) and copper (Cu). The second metal material 32 is heated at a high temperature of 600° C.˜1000° C. and molten to fill into the voids of the first metal material 31 and bond with the first metal material 31. The dielectric layer 40 is formed on the surfaces of both the first and second metal materials 31, 32. The dielectric layer 40 is selected from a group consisting of Ta₂O₅ and Nb₂O₃ or from a group consisting of Al₂O₃ and CuO. The solid electrolyte layer 41 and the graphite layer 42 are sequentially formed on the dielectric layer 40. The second conductor layer 50 is further formed on the graphite layer 42. The second conductor layer 50 is silver (Ag). The second conductor layer 50 is electrically connected with the second external terminal 52 via the conductive bonder 51. The first and second external terminals 33, 52 are made from a material selected from a grouping consisting of aluminum (Al), silver (Ag), copper (Cu), nickel (Ni), tin (Sn), tantalum (Ta), niobium (Nb), aluminum alloy (Al alloy) and silver alloy (Ag alloy). The second conductor layer 50 and one end of the second external terminal 52 are enclosed in the enclosure layer 60. The enclosure layer 60 is made from a material selected from a group consisting of resin, ethyl rubber, propyl rubber and butyl rubber. Accordingly, in the first conductor layer 30, the second metal material 32 is filled into the voids of the first metal material 31 by means of hot melt to bond with the first metal material 31. In this case, the thermal treatment temperature can be effectively lowered and the electrical conductivity of the capacitor structure 20 can be increased.

The above embodiments are only used to illustrate the present invention, not intended to limit the scope thereof. It is understood that many changes and modifications of the above embodiments can be made without departing from the spirit of the present invention. The scope of the present invention is limited only by the appended claims.

What is claimed is:

1. A capacitor structure comprising:
a first conductor layer having a first metal material and a second metal material;
a dielectric layer formed on the first conductor layer; and
a second conductor layer disposed on one side of the dielectric layer, which side is distal from the first conductor layer.

2. The capacitor structure as claimed in claim 1, further comprising a first external terminal and a second external terminal, the first external terminal extending through the first conductor layer, the second external terminal being electrically connected with the second conductor layer.

3. The capacitor structure as claimed in claim 1, wherein the first metal material is formed with voids and the second metal material is disposed in the voids.

4. The capacitor structure as claimed in claim 1, wherein the first metal material is selected from a group consisting of tantalum (Ta) and niobium (Nb).

5. The capacitor structure as claimed in claim 1, wherein the second metal material is selected from a group consisting of aluminum (Al) and copper (Cu).

6. The capacitor structure as claimed in claim 1, wherein the dielectric layer is selected from a group consisting of Ta₂O₅ and Nb₂O₃.

7. The capacitor structure as claimed in claim 1, wherein the dielectric layer is selected from a group consisting of Al₂O₃ and CuO.

8. The capacitor structure as claimed in claim 1, wherein the second conductor layer is silver (Ag).

9. The capacitor structure as claimed in claim 2, wherein the first and second external terminals are made from a material selected from a grouping consisting of aluminum (Al), silver (Ag), copper (Cu), nickel (Ni), tin (Sn), tantalum (Ta), niobium (Nb), aluminum alloy (Al alloy) and silver alloy (Ag alloy).

10. The capacitor structure as claimed in claim 1, further comprising a solid electrolyte layer and a graphite layer, the solid electrolyte layer and the graphite layer being sequentially disposed on the dielectric layer.

11. The capacitor structure as claimed in claim 10, further comprising an enclosure layer, the enclosure layer being made from a material selected from a group consisting of resin, ethyl rubber, propyl rubber and butyl rubber.

12. A manufacturing method of a capacitor structure, comprising steps of:
forming a first conductor layer having a first metal material and a second metal material;
forming a dielectric layer on the first conductor layer; and
forming a second conductor layer on one side of the dielectric layer, which side is distal from the first conductor layer.

13. The manufacturing method of the capacitor structure as claimed in claim 12, further comprising a step of providing a first external terminal and coating the first conductor layer on a surface of the first external terminal.

14. The manufacturing method of the capacitor structure as claimed in claim 12, further comprising a step of providing a second external terminal and connecting the second conductor layer with the second external terminal via a conductive bonder.

15. The manufacturing method of the capacitor structure as claimed in claim 12, wherein the second metal material is heated at a temperature of 600° C.˜1000° C. and molten to fill into the voids of the first metal material and bond with the first metal material.

16. The manufacturing method of the capacitor structure as claimed in claim 12, wherein the first metal material is selected from a group consisting of tantalum (Ta) and niobium (Nb).

17. The manufacturing method of the capacitor structure as claimed in claim 12, wherein the second metal material is selected from a group consisting of aluminum (Al) and copper (Cu).

18. The manufacturing method of the capacitor structure as claimed in claim 12, wherein the dielectric layer is selected from a group consisting of Ta₂O₅ and Nb₂O₃.

19. The manufacturing method of the capacitor structure as claimed in claim 12, wherein the dielectric layer is selected from a group consisting of Al₂O₃ and CuO.

20. The manufacturing method of the capacitor structure as claimed in claim 12, wherein the second conductor layer is silver (Ag).

21. The manufacturing method of the capacitor structure as claimed in claim 13 or 14, wherein the first and second external terminals are made from a material selected from a grouping consisting of aluminum (Al), silver (Ag), copper (Cu), nickel (Ni), tin (Sn), tantalum (Ta), niobium (Nb), aluminum alloy (Al alloy) and silver alloy (Ag alloy).

22. The manufacturing method of the capacitor structure as claimed in claim 12, further comprising a step of sequentially forming a solid electrolyte layer and a graphite layer on the dielectric layer.

23. The manufacturing method of the capacitor structure as claimed in claim 12, further comprising a step of forming an enclosure layer, the enclosure layer being made from a material selected from a group consisting of resin, ethyl rubber, propyl rubber and butyl rubber.
